(19) United States
(12) Patent Application Publication
(10) Pub. No.: US 2021/0180788 A1
(43) Pub. Date: Jun. 17, 2021

(54) Burner comprising a pre-combustion chamber

(71) Applicant: KHD Humboldt Wedag GmbH, Koeln (DE)

(72) Inventors: Ernst Schroeder, Buellingen (DE); Alex Knoch, Lohmar (DE); Karin Kluthe, Huerth (DE); Giovanni Loggia, Koeln (DE); Martin Heuser, Wiehl (DE); Silke Liedkte, Krefeld (DE); Michael Albrecht, Lohmar (DE)

(21) Appl. No.: 17/188,147

(22) Filed: Mar. 1, 2021

Related U.S. Application Data
(62) Division of application No. 15/570,068, filed on Oct. 27, 2017.

(30) Foreign Application Priority Data
Apr. 29, 2015 (DE) 102015005416.3

(51) Int. Cl. F23D 14/22; F23N 3/00; F23C 6/04; F23N 5/00; F23L 9/00

(52) U.S. Cl. CPC F23D 14/22; F23N 3/007; F23C 6/04; F23D 2214/00; F23L 9/00; F23C 2900/06041; F23N 5/003

(57) ABSTRACT

A gas burner for use in low-oxygen environments in which the oxygen concentration is insufficient to ensure complete combustion. The burner includes a central air supply that is annularly surrounded by a gas supply, thereby preventing the fuel from burning out with a delay in places where burn-out is detrimental to a system or plant.

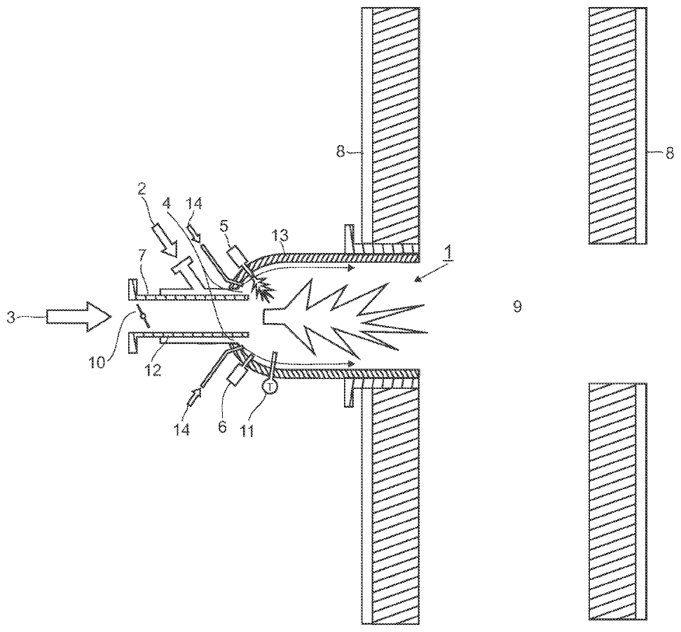

### CROSS-REFERENCES TO RELATED APPLICATIONS

This application is a divisional of U.S. patent application Ser. No. 15/570,068 filed on Oct. 27, 2017 which is a national stage of International Patent Application No. PCT/EP2016/059193 filed on Apr. 25, 2016, which claims the benefit of the German patent application No. 10 2015 005 416.3 filed on Apr. 29, 2015, the entire disclosures of which are incorporated herein by way of reference.

### BACKGROUND OF THE INVENTION

The invention relates to a gas burner for use in an oxygen-impoverished environment, the oxygen concentration of which is insufficient for supporting a complete combustion.

For producing cement clinker, a mixture consisting of calcareous stone and siliceous stone is crushed and subjected to a heat treatment in which the lime is formally freed of carbon dioxide (CO₂) and converted into burnt lime (CaO). In a further step, the raw meal, deacidified as a result of the formal freeing of CO₂, which consists of the originally non-deacidified calcareous stone and the siliceous stone which up to this point is still unaltered, is sintered in the heat, forming different calcium silicate phases. When using gas as fuel for heating calcinators of a plant for producing cement clinker, the problem frequently arises that methane-rich gases as fuel burn only incompletely despite a sufficiently high ignition temperature in the combustion chamber of approximately 800° C. This on the one hand is attributable to the fact that the oxygen concentration of the kiln flue gases of a rotary kiln, which with regard to the gas flow direction is connected upstream to the calcinator, is lower than in atmospheric air. The absolute quantity of the available oxygen in order to maintain a complete combustion of the fuel for supporting the calcination is certainly sufficient, but the oxygen concentration is insufficient for a reliable combustion. On the other hand, this is attributable to the fact that the hot meal in the calcinator splits off carbon dioxide (CO₂) and carbon dioxide inhibits the combustion process. The burnout of the gas-rich streamers in the calcinator is therefore frequently carried out initially in the kiln cyclone, which with regard to the gas flow direction is downstream of the calcinator, at the point where the solid phase and gas phase separate. This delayed combustion is undesirable, however, since it unnecessarily thermally loads the dip tube of the cyclone. Furthermore, the delayed combustion also reduces the thermal efficiency of the plant. Finally, the increased temperature in the kiln cyclone can lead to the cyclone becoming blocked which massively interrupts the operation of the plant and can be reversed only by cost-intensive shutdown and cleaning of the plant.

### SUMMARY OF THE INVENTION

It is therefore an object of the invention to provide a burner which overcomes the previously listed disadvantages.

An object upon which the invention is based is achieved by the burner having a central air supply pipe which is annularly encompassed by a gas supply pipe.

According to the invention, it is provided that some of the combustion air is already directly delivered with the fuel into the combustion chamber of the burner. In this case, the air supply pipe is of such dimensions that a substoichiometric combustion takes place in the burner itself. In this way, the effect is prevented of the burner not behaving like a nozzle for generating thrust, in which a very significant degree of combustion energy is released in the combustion chamber, but of the fuel being conditioned as a result of the substoichiometric combustion so that the complete burnout takes place under the oxygen-impoverished conditions in the presence of carbon dioxide and hot meal. In the vicinity of the calcinator, there is sufficient oxygen available for a complete combustion to be able to take place. This burnout actually takes place, however, only when the conditioning in the burner, described here, takes place. Within the scope of this invention, it is assumed that the activation energy for igniting the fuel, especially that of methane-rich natural gas, initially requires a high oxygen surplus in the presence of high temperature.

As a result of the conditioning, the natural gas, as an example of the fuel, is partially oxidized. After monitoring the combustion using the burner according to the invention, the partially oxidized combustion residues burn out more easily under the conditions of the calcinator. Therefore, no delayed combustion, which takes place in the kiln cyclone or immediately downstream of the calcinator, is noticed.

Before pre-conditioning, a λ-value of 0.05 to 0.3 has been proved to be effective. In a preferred embodiment of the burner according to the invention, it is provided that provision is made for an control device, preferably in the form of a throttle valve, which by an adjustment of the supplied air flow and fuel flow sets an air/fuel ratio λ to a value of 0.05 to 0.3, wherein the control device preferably sets the desired λ-value by means of a closed-loop control device with a control loop via a measured temperature in the combustion chamber and/or via a spectometrically measured gas concentration.

In a simple form of the invention, it is provided that an adjustable throttle valve limits the air supply into the burner. A once-only setting of the throttle valve leads to a permanent uniform λ-value of 0.05 to 0.3. According to a further embodiment of the invention, it is provided that an existing closed-loop control device constantly adjusts the control device so that a desired uniform λ-value of 0.05 to 0.3 is maintained. In the control loop, the temperature in the combustion chamber is measured in the process and/or the gas composition is determined via a spectometrically operating λ-probe. In order to maintain the desired λ-value of 0.05 to 0.3, in the event of a drop in the measured temperature or in the event of a reduction of the concentration of typical combustion products which is measured via the spectometrically operating λ-probe, the air supply is increased and vice versa. It is also possible to utilize both the measured temperature and the gas composition, measured via the spectometrically operating λ-probe, with the aid of a computer model for controlling the air supply.

In a simpler, very robust embodiment, it suffices if provision is made for a simple flame monitor which determines the absence of conditioning in the form of a partial combustion/oxidation and if, in the event of the absence of combustion being detected, the simple closed-loop control device increases the air supply, and vice versa. Compared with the continuously operating closed-loop control device with continuous values of temperature and combustion gas concentration, the closed-loop control device with a flame monitor works on a two-point basis, with the states “flame sufficient” and “flame insufficient (no longer sufficient)”.

In a further embodiment of the invention, it is provided that in the region of the mixing of fuel and air as oxidation means, an annularly disposed group of nozzles, forming a spiral vortex or a laminar flow, is arranged, via which the fuel is mixed with the centrally injected air. Serving as oxidation means in the simplest case can be tertiary air which, as preheated air, supports the partial combustion of the fuel, in this case methane-rich natural gas, as an example. Depending on methane concentration in the natural gas, which is frequently accompanied by further poorly combustible gases, such as nitrogen (N₂) as being very difficult to combust, and carbon disulfide (H₂S) as being poorly combustible with regard to the desired thermal output, it can be provided to provide an oxidation means in the form of oxygen-enriched air as oxidation means. Air enriched with ammonia or amines is also a possibility, for example, in order to control the nitrogen oxide concentration. The arrangement of nozzles enables the flame formation. The flame can be formed as a laminar flame or as a vortex flame in order to control the shape of the flame cone or also the flame length.

For fuels which have an erratic ignition behavior, such as natural gas with fluctuating methane content, a pilot burner can be provided. To this end, it is provided that provision is made for at least one additional pilot burner which reliably ignites the mixture of fuel and oxidation means in the region of the combustion chamber. The pilot burner, for its part, is operated with reliable fuels with uniform ignition tendency in order to ignite the significantly larger quantity of fuel in the burner and in order to maintain the combustion flame. The ignition can take place with suitable fuels, but also by means of an electric igniter which, for example, induces the ignition via continuous electric arcs, via electric arc pulses or via a hot wire.

Since the ignition already takes place in the burner, it is necessary to cool the burner itself so as not to burn and prematurely age the walls of the burner. To this end, it is provided that the inner walls of the burner have at least one air suction nozzle by means of which sucked-in ambient air flows into the burner in the region of the walls of said burner and as a result cools the inner walls of the burner.

### BRIEF DESCRIPTION OF THE DRAWINGS

The invention is explained in more detail with reference to the following FIGURE. In the drawing:

The FIGURE shows a vertical cross section through a burner according to the invention.

### DETAILED DESCRIPTION OF THE PREFERRED EMBODIMENTS

Shown in the FIGURE is a vertical section through a combustion chamber 1 according to the invention in which the combustible gas 2 is mixed with an oxidation means 3, preferably hot tertiary air from the clinker cooler or kiln flue gas with sufficient residual oxygen, and substoichiometrically combusted. In this case, the aim in nominal operation is an air/fuel ratio λ of 0.05-0.3 which, depending on the fuel quantity which is required for the calcination process, can be adjusted by controlling the inflow rate of the oxidation means 3 by means of a throttle valve 10. The reactive and combustible gas mixture forming in the combustion chamber 1 can then burn out in the calcinator interior space 9 with the main part of the tertiary air from the clinker cooler and the residual oxygen of the kiln flue gas.

For the mixing of oxidation means 3 and combustible gas 2 use is made of an injector 4 in which, as a result of flow velocity of the combustible gas 2, the oxidation means 3 is sucked into the reaction chamber. This injector 4 can be arranged according to the invention as an annular gap, a nozzle ring or even be swirled, i.e., set at a tangent to the longitudinal axis.

If the temperature of the oxidation means 3 should not be sufficient for a reliable ignition, the reaction can be initiated by means of a suitable pilot burner 5, alternatively by means of an electric ignition device. For monitoring the reaction, a visual flame monitor 6 or even a thermoelement 11 can be used.

The wall of the combustion chamber 1 and of the supply pipe 7 for the oxidation means 3 can be protected against high temperatures and reaction products by means of suitable fireproof materials 12, 13 or even by means of a film consisting of sucked-in ambient air 14.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

Claimed is:

1. A method for operating a calcinator in a plant for producing cement clinker, in which lime, as hot meal, is freed of carbon dioxide and converted into burnt line, the method comprising:
providing a gas burner for use in an oxygen-impoverished environment, an oxygen concentration of which is insufficient for supporting a complete combustion, and,
supplying methane-rich natural gas as a fuel to the gas burner wherein the burner has a central air supply pipe which is annularly encompassed by a gas supply pipe,
wherein the air supply pipe is dimensioned such that a sub-stoichiometric combustion takes place in the burner, and,
wherein the fuel is conditioned as a result of the sub-stoichiometric combustion such that a complete burnout takes place under the oxygen-impoverished environment in the calcinator in the presence of carbon dioxide and hot meal,
wherein, in a region of a mixing of fuel and air, an annularly disposed group of nozzles, forming a spiral vortex, is arranged, which mix the fuel with the air.

2. The method as claimed in claim 1, further comprising:
providing a control device in the form of a throttle valve, which, by an adjustment of the supplied air flow and fuel flow, sets an air/fuel ratio λ to a value of 0.05 to 0.3,
wherein the control device, by means of a closed-loop control device with a control loop, sets the desired λ value via at least one of a measured temperature in the combustion chamber or a spectrometrically measured gas concentration.

3. The method as claimed in claim 1, further comprising:
providing at least one additional pilot burner which, in the region of the combustion chamber, reliably ignites the mixture of injected fuel and oxidation means.

4. The method as claimed in claim 1, wherein inner walls of the gas burner have at least one air suction nozzle, by means of which, sucked-in ambient air flows into the gas burner in the region of the walls of said burner and, as a result, cools the inner walls of the gas burner.
